(19) United States
(12) Patent Application Publication
(10) Pub. No.: US 2006/0021232 A1
(43) Pub. Date: Feb. 2, 2006

(54) Knife with adjustable guide

(76) Inventors: Jurgen Schmidt, Montvale, NJ (US); Marvin Levy, Montvale, NJ (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/909,973

(22) Filed: Aug. 2, 2004

(51) Int. Cl. B26B 29/00

(52) U.S. Cl. 30/293

(57) ABSTRACT

A knife with an adjustable blade guide includes a groove extending from a left end of the handle to a right end of the handle (in a view from which the handle rests on a surface), an extension from the blade guide insertable into the groove of the handle from both the left and right ends, such that the blade guide's position within the groove may be adjusted to determine the spacing between the guide and the blade and thereby the thickness of the slices obtained.

### FIELD OF INVENTION

The present invention relates to cutting instruments, such as knives, and, more particularly, to knives having an adjustable guide attachment.

### BACKGROUND OF INVENTION

To address the need to quickly exercise the accurate and uniform slicing of a solid food item with the use of an ordinary knife to produce a plurality of slices of equal thickness, various types of knife slicing guides are commercially available.

Prior art knives having a blade guide generally fall into two categories. Those with the guide attached at two distal points on the blade, and those in which the guide is supported at only one of its ends thereby forming a cantilever beam structure.

In knives having a blade guide attached at both ends, the food being sliced has a tendency to get caught between the blade and the guide. Accordingly, to overcome this and other shortcomings, the guide may be attached to the blade only at the end proximate to the handle. In such cantilever beam construction, disengaging the knife from the item to be cut can be achieved simply by pulling the knife back toward the user. A cantilever-type guide also typically allows the user to adjust the spacing of the guide more conveniently.

U.S. Pat. No. 3,110,964, issued Nov. 19, 1963 to Szekely, also discloses a knife with adjustable guide having a free end and a threaded knob at the opposed end of the guide to adjust the spacing between the guide and the blade.

Another example of a knife having a cantilever guide is disclosed in U.S. Pat. No. 3,178,817 issued Apr. 20, 1965 to Rubinstein. In Rubinstein, the adjustable guide is secured to a side of the knife handle by a channel-shaped bracket.

The knives described in each of Szekely and Rubinstein suffer from the fact that they include multiple components to secure the guide to the blade, which may be relatively difficult to keep clean. These knives also fail to allow for the easy modification from right-handed to left-handed use, and do not allow the user to place the knife to rest evenly on a flat surface.

The limitations identified in the foregoing make apparent that prior art knives provided with an adjustable guide are not fully satisfactory. Thus, it appears desirable to provide a knife with a cantilever-type adjustable guide having improved features that alleviate the shortcomings associated with conventional prior items, but which is nevertheless engineered to facilitate its fabrication, at the same time improving, or at least maintaining, its reliability and relatively low cost.

### SUMMARY OF INVENTION

The present invention features a knife or other cutting instrument configured to allow the user to cut slices of food (or other substance) of relatively even thickness. According to one aspect of the present invention, the knife comprises a handle, an elongated blade extending from one end of the handle, and a guide spaced apart from, and adjustable with respect to, the blade. The blade guide is formed from a single, unitary, piece of material.

According to a preferred embodiment of the invention, the knife with an adjustable blade guide includes a groove extending from a left end of the handle to a right end of the handle (in a view from which the handle rests on a surface), an extension from the blade guide insertable into the groove of the handle from both the left and right ends, such that the blade guide's position within the groove may be adjusted to determine the spacing between the guide and the blade and thereby the thickness of the slices obtained.

These and various other features as well as advantages, which characterize the present invention, will be apparent from a reading of the following detailed description and a review of the associated drawings.

### BRIEF DESCRIPTION OF THE DRAWINGS

An embodiment of the present invention will now be fully described, by way of example, with reference to the appended drawings, wherein like numerals denote like elements and:

FIG. 1 is a perspective view of a Knife with an Adjustable Guide in accordance with one embodiment of the invention;

FIG. 2 is a sectional view of the Knife with Adjustable Guide taken along line 2-2 shown in FIG. 1;

FIG. 3 is a partial sectional view of the Knife (with the Adjustable Guide eliminated for clarity) taken along line 3-3 shown in FIG. 1;

FIG. 3A is a partial sectional view of the Knife (with the Adjustable Guide illustrated in dotted lines) taken along line 3-3 shown in FIG. 1;

FIG. 4 is a perspective view of a wire used to form the guide;

FIG. 5 is a side view of the Adjustable Guide shown in FIG. 4;

FIG. 6 is a perspective view of the Adjustable Guide positioned to align with the groove in the knife handle.

### DETAILED DESCRIPTION OF A PREFERRED EXEMPLARY EMBODIMENT

The invention relates to cutting implements, such as knives, having an adjustable guide in which the adjustable guide is secured to the knife and is adjustable with respect to the blade by way of sliding an opposed end of the adjustable guide into a groove that extends from one end to an opposing end of the handle. Those skilled in the art should appreciate that the term “knife” as used herein from time to time should also be understood to connote other types of cutting implements as well.

Referring to the figures, a knife 10 according to the invention includes an elongated blade 12 extending along a longitudinal axis 13 and connected to a handle 14. Knife 10 also includes a guide 16 spaced apart from blade 12 and substantially parallel to blade 12. Adjustable guide 16 is preferably formed of a single piece of metal and includes a free end 20 and opposed extension end 22, opposed extension end 22 substantially perpendicular to free end 20 (opposed extension end 22 may be flattened, as illustrated in FIG. 4, or may have a cylindrical or any other shape that conforms to groove 33 discussed below).

The distance between blade 12 and guide 16 can be adjusted to any desired position by sliding opposed extension end 22 of guide 16 into a groove 33 (or “channel” or “bore”) that extends through handle 14. The groove 33 extends perpendicular to the plane of blade 12 and guide 16.

In accordance with a preferred embodiment of the present invention, handle 14 further includes two threaded apertures 18, configured to receive a mounting member, such as a screw, to engage opposed extension end 22 of guide 16.

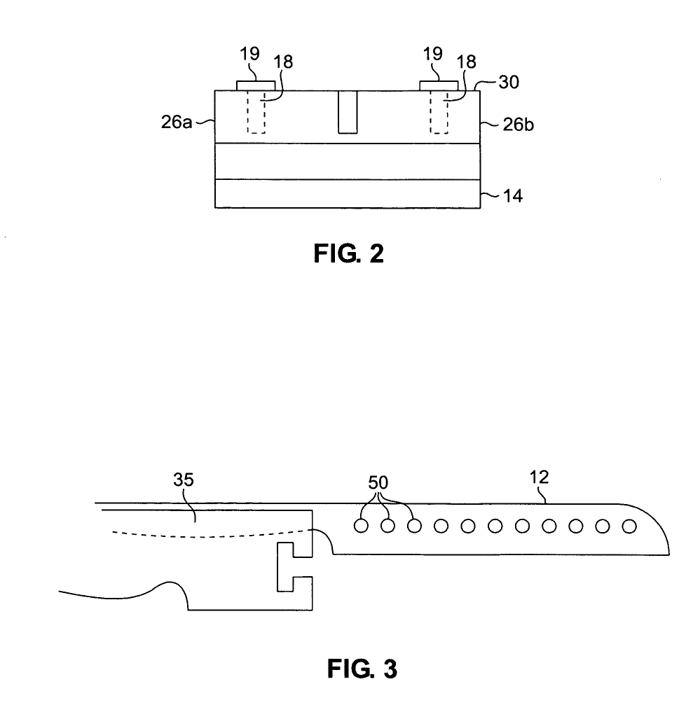

Referring more particularly to FIG. 2, apertures 18 are preferably located towards the outer ends of oppositely spaced apart sides 26a/26b of handle 14 in a forward region of handle 14.

Mounting members 19 (illustrated as screws) protrude above an upper surface 30 of handle 14, and allow the user to easily and conveniently adjust the space between blade 12 and guide 16 simply by sliding opposed extension end 22 of guide 16 within bore 33, and tightening mounting members 19.

Of course, those skilled in the art will appreciate that mounting members 19 may not be needed as opposed extension end 22 may also be “press fit” or held into position in bore 33 by friction, thereby allowing the desired positioning to be held in place.

Stability of guide 16 is primarily achieved by having a close fit between flattened opposed extension end 22 and bore 33 formed through handle 14 in a direction perpendicular to axis 13, thereby effectively allowing linear displacement only of guide 16 toward or away from blade 12 as opposed extension end 22 moves in and out of bore 33.

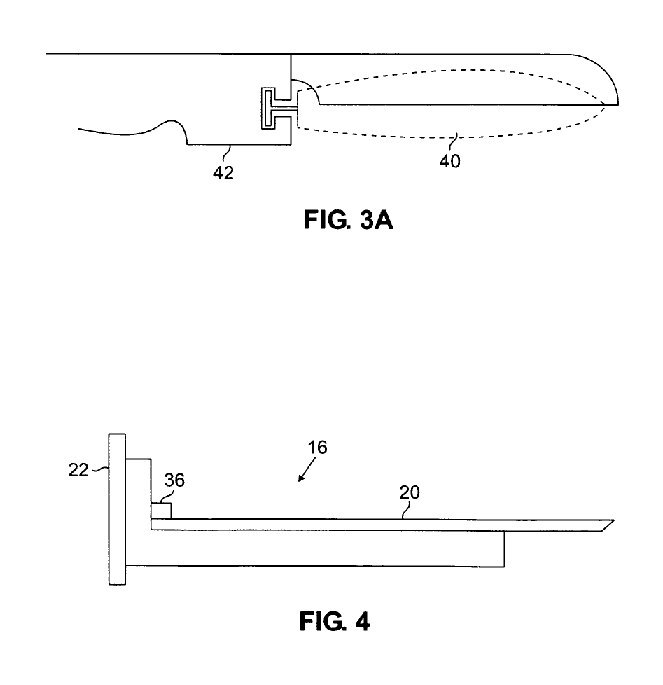

Handle 14 is advantageously made of wood, but of course could be made of plastic, hard molded fiberglass reinforced nylon or the like to improve durability and strength without adversely affecting its weight. Having handle 14 made of moldable material also facilitates positioning bore 33 with respect to axis 13 and facilitates forming bore 33 to conform to opposed extension end 22. Handle 14 is secured to blade 12 at tang 35 (illustrated in FIG. 3).

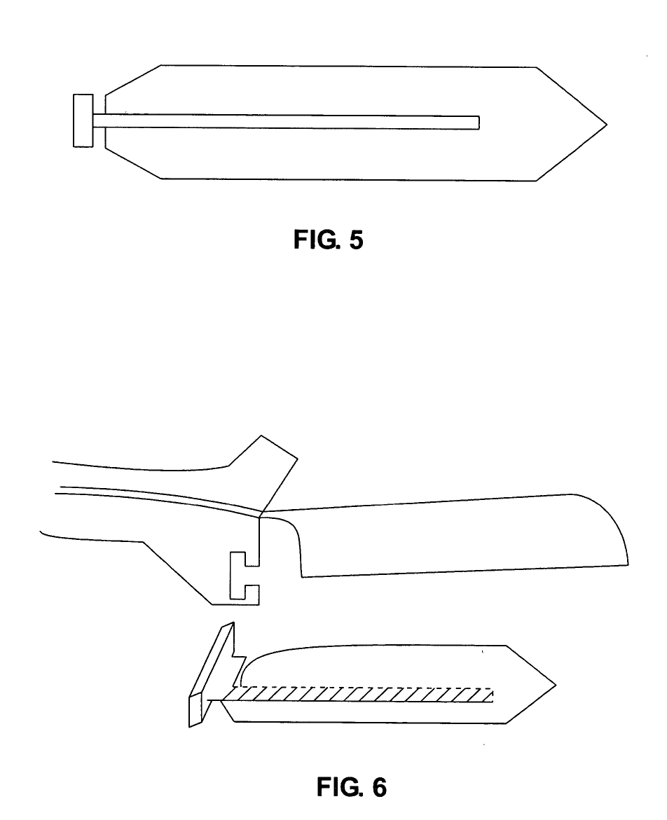

Guide 16 will now be described with particular reference to FIGS. 4-5. Guide 16 is advantageously made from a unitary piece of material such as metal. The material used to manufacture guide 16 should be of appropriate hardness so that guide 16 can be supported at extension end 22 when extension end 22 is received in bore 33. Stainless steel is typically preferred, particularly in food applications.

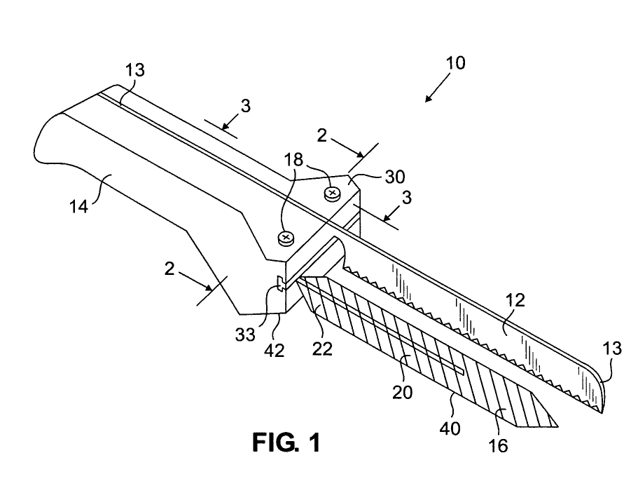

As shown in FIG. 4, a substantially ninety degree angle is formed between opposed extension end 22 and free end 20 of guide 16. Referring to FIGS. 1 and 6, a single bend 36 is formed in the region of opposed extension end 22 by bending guide 16, as illustrated, substantially perpendicular to the plane of the free end 20 of the guide, such that when the opposed extension end 22 of guide 16 is inserted into bore 33 of handle 14, a substantial portion of guide 16 (i.e., the free end portion 20) extends in a direction substantially parallel to blade 12 (see FIG. 3A), and presents a flat surface parallel to that of the knife blade 12 (those skilled in the art will appreciate that while a preferred embodiment of the invention includes a guide 16 that is formed from single unitary piece of metal, of course opposed extension end 22 may be formed separately from free end 20 and later attached thereto by any known method).

As best illustrated in FIG. 5, guide 16 is symmetrical around an axis through its longitudinal center, which allows for insertion of guide 16 into either side of the groove that extends through handle 14. This allows a user to easily alter between right-handed and left-handed use, as needed, by inserting guide 16 into either side 26a/26b of handle 14 and laterally sliding guide 16 to a desired position.

As shown in FIG. 3A, when guide 16 is inserted into groove 33 (again, in either a right-handed or left-handed configuration), a bottom portion 40 rests at the same level as the bottom flat surface 42 of handle 14. This feature of a preferred embodiment of the invention allows the knife handle and guide blade to rest on a flat surface when not in use while maintaining the blade 12 above the surface.

Mounting members 19 extend through bore 33 formed in a region of handle 14 and engage extension end 22 to lock the displacement of guide 16 relative to blade 12.

Those skilled in the art will appreciate that the surface area of blade 12 which comes into contact with the food or other substance to be sliced, may also include a plurality of holes 50 (included in the embodiment illustrated in FIG. 3), which may be circular, elongated, etc., thereby reducing the amount of material which clings to blade 12 and allowing the user to cut more easily and accurately because blade 12 does not encounter as much resistance from the material being cut.

It can therefore be appreciated from the foregoing that a knife with adjustable guide according to the present invention alleviates some of the shortcomings typically associated with such prior art knives. In particular, a knife of the present invention is of simple construction and relatively low manufacturing cost, while including a guide that is symmetrical around an axis through its longitudinal center, allowing for insertion of guide for right-handed and left-handed use, as needed.

Reference throughout this specification to “one embodiment” means that a particular feature, structure, or characteristic described in connection with the embodiment is included in at least one embodiment of the present invention. Thus, the appearances of the phrase “in one embodiment” are not necessarily all referring to the same embodiment, though they may. Furthermore, the particular features, structures, or characteristics may be combined in any suitable manner in one or more embodiments.

Although various embodiments are specifically illustrated and described herein, it will be appreciated that modifications and variations of the invention are covered by the above teachings and are within the purview of the appended claims without departing from the spirit and intended scope of the invention.

What is claimed is:

1. A knife with blade guide adjustable for left-handed and right-handed use, said knife comprising:
an elongated blade extending from one end of the handle;
a handle, wherein said handle has a groove extending, substantially perpendicularly from said elongated blade, from a first side to an opposite side of said handle; and
a blade guide, adjustable with respect to a distance between said blade guide and said elongated blade, wherein said blade guide is symmetrical such that said blade guide is engageable with the groove of said handle from both the first side and the opposite side of said handle.

2. The knife of claim 1, wherein said blade guide is symmetrical around an axis through its longitudinal center.

3. The knife of claim 1 wherein said blade guide has a free end and an opposed extension end such that the opposed extension end is substantially perpendicular to the free end.

4. The knife of claim 3 wherein the groove is configured to slidably receive the opposed extension end of said blade guide.

5. The knife of claim 4 wherein the opposed extension end has a press-fit relationship with the groove.

6. The knife of claim 1 wherein the handle is made of a plastic.

7. The knife of claim 1 wherein the handle is made of wood.

8. The knife of claim 1 wherein the elongated blade has a cutting edge and wherein the cutting edge of said blade rests in a plane above a plane of a bottom edge of said blade guide.

9. The knife of claim 1 wherein a bottom edge of said blade guide is at a same level as a bottom plane of said handle.

10. The knife of claim 1 wherein said blade guide is unitary, formed from a single piece of material.

11. The knife of claim 1, wherein said elongated blade has a plurality of holes therein to reduce the surface area of said blade.

12. A knife with adjustable blade guide comprising:
a handle;
an elongated blade extending from one end of the handle; and
a guide adjustable with respect to the blade, the adjustable guide having a portion spaced apart from the blade,
wherein said handle has a groove extending, perpendicularly from said elongated blade, from a first side to an opposed second side of said handle, said groove cooperating with the guide for adjustment of the space between the guide and the blade.

13. The knife of claim 12, wherein said guide is symmetrical around an axis through its longitudinal center, thereby allowing said guide to cooperate with the groove from both the first side of said handle and the second side of said handle.

14. The knife of claim 13 wherein said guide has a free end and an opposed extension end such that the opposed extension end is substantially perpendicular to the blade.

15. The knife of claim 14 wherein the guide has a free end and an opposed extension end, the groove being configured to slidably receive the opposed extension end of said guide.

16. The knife of claim 15 wherein the opposed extension end has a press-fit relationship with the groove.

17. The knife of claim 12 wherein the blade has a cutting edge and wherein the cutting edge of said blade rests in a plane above a plane of a bottom edge of said guide.

18. The knife of claim 12 wherein a bottom edge of said guide is at a same level as a bottom plane of said handle.

19. A knife comprising:
an elongated blade;
a handle having a bore, extending from one end to an opposite end perpendicular to said elongated blade, through the handle;
a guide having a portion spaced apart from, and adjustable with respect to, said blade and extending substantially parallel thereto, said guide further having a free end and an opposed extension end disposed on opposite sides of the portion, the bore slidably receiving at least a part of the opposed extension end and conforming thereto to increase stability of the free end; and
mounting means extending into said handle, said mounting means cooperating with said opposed extension end of said guide for adjustment of the space between said guide and said blade.

20. The knife of claim 19 wherein said handle has a pair of spaced apart apertures extending, perpendicular to the opposed extension end of said guide, from a top surface of said handle to the bore,

21. The knife of claim 19, wherein said mounting means comprises a pair of thumb screws and wherein said thumb screws are inserted into the pair of spaced apart apertures to secure said guide within the bore at a desired adjustment of the space between said guide and said blade.
